(19) United States
(12) Patent Application Publication
(10) Pub. No.: US 2018/0172262 A1
(43) Pub. Date: Jun. 21, 2018

(54) Fully Integrated Vanity Lighting and Entertainment System

(71) Applicant: Alex Garcia, Victorville, CA (US)

(72) Inventor: Alex Garcia, Victorville, CA (US)

(21) Appl. No.: 15/383,373

(22) Filed: Dec. 19, 2016

(51) Int. Cl. F21V 33/00; G06F 3/16; H04R 1/02; G10L 19/16; A45D 42/10; A45D 42/16

(52) U.S. Cl. CPC F21V 33/004; G06F 3/165; H04R 1/028; H04R 2420/07; A45D 42/10; A45D 42/16; H04R 2420/09; G10L 19/167

(57) ABSTRACT

A vanity mirror combining lighting and entertainment elements into a single integrated unit is provided. The mirror may be supported by a frame configured to electronically communicate with a plurality of lights, at least one audio speaker, and a microcontroller. The microcontroller may comprise a signal decoder operative to receive and transmit audio signals from a personal electronic device, such as a smart phone. Signals may be received wirelessly, via Bluetooth or other wireless communications protocols, or by way of USB cable(s), secure digital memory card, and even wired auxiliary input. An additional auxiliary power outlet may be provided to enable electronically coupling one or more additional grooming or other electronic devices to the frame. Means for selectively adjusting intensity of illumination and volume of transmitted audio are also provided.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to lighting systems and, more particularly, to a combined entertainment and vanity lighting system and mirror display in service of grooming routines.

### BACKGROUND

Grooming routines, including for example, aesthetically arranging ones hair, shaving one's face, and applying makeup, can be time consuming and tedious. A variety of aids have been developed to ease various inconveniences related to such routines and also make such routines associated with the difficulties more efficient and enjoyable.

One device used in grooming is a lighted vanity mirror such as the variations described in U.S. Pat. No. 6,318,877 to Dehn for a foldable light bar frame configured for convenient transportation; U.S. Pat. No. 6,932,488 to Horn for a lighting system that is concealable when not in use; U.S. Pat. No. 7,484,878 to McCole for a mountable vanity-lighting system having segmented and optionally joinable pieces; and U.S. Pat. No. 8,118,445 to Patz for angling vanity lights to illuminate a user's face in a manner that mimics daylight conditions, for example. Each of these generally operate by illuminating a user's reflection to make procedures practiced during grooming routines more clearly visible to the person practicing them. And each proposal suggests improvements over traditional designs comprising mirrors, which may be considered necessary tools for carrying out grooming routines. Still, these fail to solve the problem of tedium that characterizes grooming in general.

As such, some proposals have been made to integrate traditional grooming tools, such as lighted vanity mirrors, with contemporary technology for entertainment purposes. For instance, U.S. Pat. No. 8,880,360 to Mischel teaches a media display device, such as a television, coupled to a mirror so that the media is viewable within a portion of a field apparently occupied by a mirror. However, this proposal is also deficient because the entertaining television may visually distract from, if not also physically interfere with, a user's ability to regard their own face and body in the mirror. In other words, there is an undesirable risk that the visual display may obscure the user's reflection in the mirror and that further providing visual stimulation might distract a user from visually attending to his or her appearance. This proposal undesirably sacrifices utility of the mirror in favor of entertainment.

Thus, none of those proposals in existence adequately solve the problem of combining useful and entertaining lighted vanity mirrors. Thus, there remains a need for a fully integrated vanity lighting and entertainment system.

### SUMMARY

The present disclosure is directed to a lighted mirrored device for use in grooming. For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

One embodiment of a fully integrated vanity lighting system, may comprise a mirror supported by a frame in electrical communication with a light source, a microcontroller, at least one speaker, an auxiliary power outlet, and means for powering each of the same. More particularly, it is contemplated that the microcontroller may be operative to receive audio signals from a personal electronic device and transmit such signals through the at least one speaker so that a user may play music or other audible entertainment, including any digital media electrically stored as an MP3, WMA and/or other audio filed known to those skilled in the art, through the frame while using the mirror.

In accordance with one embodiment, the microcontroller may comprise more broadly a digital signal decoder having a wired or wireless communication module operative to receive and transmit audio signals from the personal electronic device.

One example of a wireless communication available for use within the fully integrated vanity lighting and entertainment system may be an 802.15.4 platform that is compliant with communications protocols such as those sold under the trademark ZigBee®. Other wireless communication modules may also be used. For example, the wireless communication module may be capable of sending and receiving data wirelessly using Wi-Fi or cellular networks. In another embodiment, said module may both ZigBee® and WiFi communications modules.

One embodiment of the fully integrated vanity lighting and entertainment system would utilize a WiFi microcontroller to wirelessly network the light with a user's personal electronic device. An example of such a controller is the 88MC200 microcontroller sold under the trademark Marvell®. Such a microcontroller may have features such as IEEE 802.11n, antenna diversity, beam forming, access-point mode, and Wi-Fi direct. This particular microcontroller comprises a 200 MHz max CPU, 512 KB SRAM, serial I/O interfaces which include UART(4), SPI(3), and I2C(3). Said microcontroller may also comprise high-speed connectivity interfaces for SDIO and USB-OTG with integrated PHY.

Another example of a microcontroller that may be utilized in one embodiment of the fully integrated vanity lighting and entertainment system is an IEEE802.15.4 standard-compatible integrated radio frequency (RF) transceiver and wireless microcontroller. Such a microcontroller may have low-power, IP-based wireless connectivity enabled by the open source JenNet-IP networking software or other low powered communications protocols such as ZigBee®.

Using a microcontroller and, in some embodiments, even allowing the fully integrated vanity lighting and entertainment system to communicate with personal electronic devices will allow for a variety of advantages of traditional vanity lights. For instance, users may be able to control the character and intensity of sound, such as music or other audible media, transmitted through the speaker(s) through wireless-enabled computer, tablet, smart-phone, or other audio-file storage device.

With respect to any software used to communicate between a computer, tablet, or smart phone and the vanity lighting and entertainment system, using a microcontroller such as any of those heretofore described and similar devices, the software will allow programmers to develop and use new applications around the capabilities offered by the system's controls. For example, the system with such microcontroller may be able to search and access the web for additional audio files for transmission through the speakers.

In other embodiments, a personal electronic device such as a computer, smartphone, or tablet may be plugged directly into the vanity lighting and entertainment system, such as by way of any of a USB cable and wired auxiliary input known to those skilled in art.

The light source may comprise any light as may be desirable to illuminate a user's features while grooming. For instance, globe light blubs may be mated with sockets disposed along a perimeter of the frame. As another embodiment, track lights may be secured to a portion of the frame. As still another example, light emitting diodes may be recessed in or placed along a portion of the frame. It should be apparent that the type and particular placement of light source should not limit the invention. Indeed, one skilled in the art will recognize that different types of lights and different arrangements may offer particular benefits over others. For instance, some lights may be preferable for their ability to mimic daylight conditions, others for their ability to mimic indoor lighting conditions, and still others for their versatility. Thus, the foregoing are offered by way of example only and not of limitation.

In some embodiments, a dimmer switch, known to those skilled in the art, may be disposed on a portion of the frame to enable selective adjustment of the intensity of any light transmitted by such light source. One skilled in the art will recognize that the intensity of the light may also or alternatively be controlled remotely by the personal electronic device.

Of course a means for powering the frame, light source, microcontroller, one or more speakers, and auxiliary power outlet may take many forms. For instance, a power cord such as any of those commonly available in the marketplace may be provided to electrically couple such elements to any power outlet found in a home, hotel, bathroom or other place of accommodation. As another example, each element may be powered by one or more batteries or even an electrical generator.

In an embodiment, the auxiliary power outlet may be configured to further transmit aforementioned power to one or more additional electronic devices that may be coupled to such auxiliary power outlet. It is contemplated that providing an auxiliary power outlet as an element of the fully integrated vanity lighting and entertainment system may avoid a common problem of power allocation. In other words, while there may be a limited number of power outlets available for use in places where grooming routines may be practiced, providing an auxiliary power outlet may ensure that a user may contemporaneously power the lighting and entertainment system as well as additional electronic devices. Any power outlets lost due to powering the system may be recovered by the same. In some embodiments, the auxiliary power outlet may comprise an about 110 volt to about 120 volt alternating current outlet disposed on the frame. It is contemplated that such outlet may be configured to receive power cords associated with a variety of common grooming implements, such as a hairdryer, hair straightener, facial steamer, and others. Indeed, one may even electrically couple his or her personal electronic device to the auxiliary power outlet to prevent draining any local battery associated with such device while transmitting media through the speakers.

The vanity lighting and entertainment system may be configured to enable placement of the of the system in any convenient location. For instance, a supportive base may be disposed along or, in some cases, extend from a bottom portion of the frame to support the mirror and frame in an upright position on a surface such as a desktop, tabletop, or even countertop. In some embodiments, the frame may be rotatably secured to the supportive base so that the angle of the mirror, with respect to the supportive surface, may be adjusted.

In another embodiment, means for supporting the frame on a horizontal surface may be disposed along a portion of the frame. For instance, the frame may define a plurality of holes sized to receive hooks or nails for mounting the frame and mirror vertically against a wall. In another embodiment, a plurality of suction cups may be provided to negatively press the frame against a smooth surface, such a tiled wall or even another mirror.

Thus, it is an object of the invention to integrate lighting, entertainment systems, and means for transferring electronic power in a unified device.

It is a further object of the invention to enable wireless control of features characterizing the unified device.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a front perspective view of an embodiment of the fully integrated vanity lighting device.

FIG. 2 shows a front view of an embodiment of the fully integrated vanity lighting device.

FIG. 3 is a block diagram of an embodiment of the fully integrated vanity lighting device electrically coupled to a power source along with an exemplary grooming device and personal electronic device.

FIG. 4 illustrates one embodiment of a network in which a fully integrated vanity lighting device is capable of being operated wirelessly.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

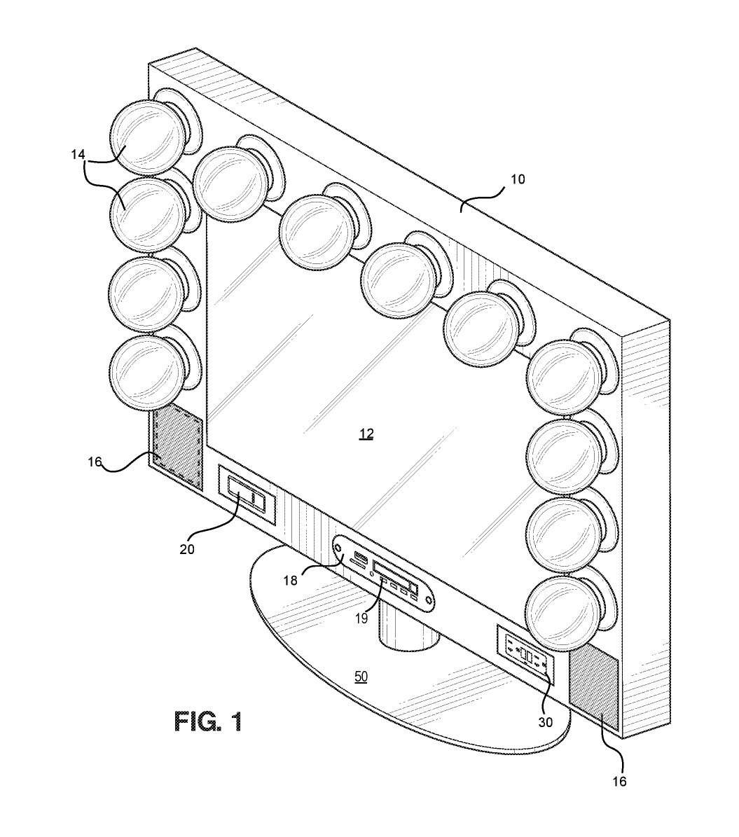

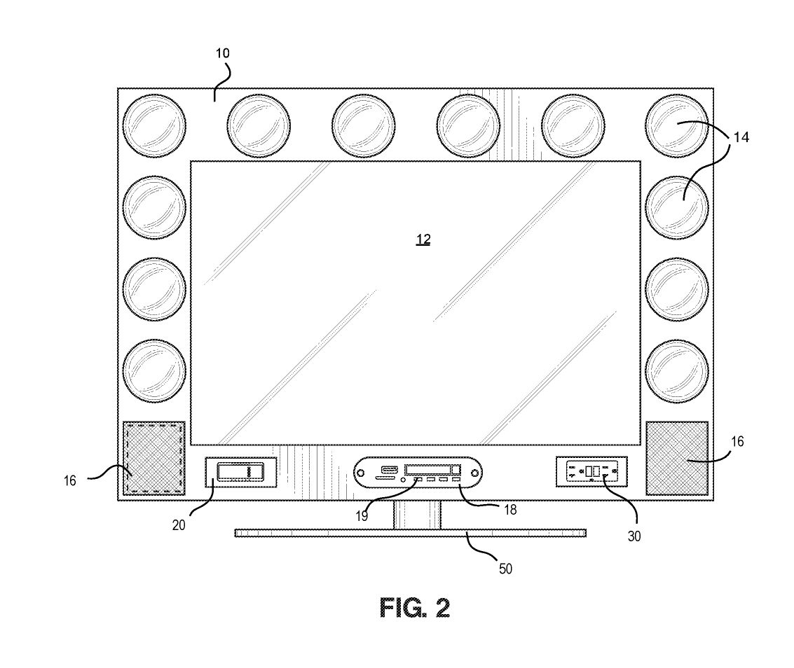

FIGS. 1 and 2 illustrate alternative views of one embodiment of a fully integrated vanity lighting and entertainment system. In particular, the system may comprise an electric frame 10 configured to support a mirror 12 and a light source. The light source may be a plurality of light bulbs 14 such as globe lights shown to be electrically coupled with the frame 10, however other light sources are contemplated. For instance, the light source may comprise light emitting diodes integrated on the body of the frame 10. One skilled in the art will recognize that various lights comprising the light source may be desirable over others for reasons such as intensity, adjustability, replaceability, durability, and others. Thus, it is to be understood that the particular light source shown in the drawings is offered by way of non-limiting example only.

Next, one or more audio speakers 16 may be incorporated into the body of the frame 10. Of course, the number, configuration, and placement of speakers 16 may vary. The number and placement illustrated in the figures is offered by way of example only and not of limitation. A digital amplifier board may be provided and similarly incorporated into the body of frame 10, though obscured from view, to power all of the one or more speakers 16. In a particular embodiment, the digital amplifier may functionally modulating transmissions from a microcontroller comprising an audio decoder board 18, also integrated the body of the frame 10, to audibly entertain a user. More particularly, the decoder board 18 may be a MP3 WMA Bluetooth decoder board and wireless module configured to wirelessly receive and transmit communications signals defined by Bluetooth protocols themselves received from a user's personal electronic device. Such personal electronic device may be any computer, tablet, smartphone or other device capable of storing and/or accessing audio media. As described above, other, low power wireless communications protocols are also contemplated. Indeed, the decoder board 18 may even comprise one or more ports configured enable wired communication via USB, SD Card, and even auxiliary input.

In some embodiments, manually operable control buttons 19 may be disposed on a portion of the decoder board 18, enabling selective playback, volume control, and other actions, though it is also contemplated that the personal electronic device may be operative to remotely control such features. In some embodiments, a separate remote control may even be provided to control such features.

The personal electronic devices in wireless or wired communication with the frame may include a proprietary user interface having stored thereon a variety of computer-executable commands. By way of example and for illustration purposes only, said command may be any or a combination of that to optionally turn on and/or brighten or dim the lights comprising the vanity lighting and entertainment system and even control audio transmitted through the one or more speakers. Of course, it will be understood by those of ordinary skill in the art, that said proprietary software may be used to execute a wide variety of commands or macros different from those mentioned above.

Other means may be disposed directly on the body of the frame 10 for controlling various functionalities. For instance, a dimmer switch 20 known to those skilled in the art may be provided to enable a user to manually control lighting brightness.

In one embodiment, an auxiliary power outlet 30 may be disposed on the body of the frame 10 as well. Such auxiliary power outlet 30 may be configured to transmit power supplied to the light source 12, speakers 16, and audio decoder 18 to further power to one or more additional electronic devices that may be coupled to such auxiliary power outlet 30. For instance, heated implements such as hair curling irons, hair straightening irons, hair driers, and others are sometimes used over the course of grooming routines. These typically include power cords and must be plugged into a power outlet to effectively operate. Thus, it is contemplated that providing an auxiliary power outlet 30 as an element of the fully integrated vanity lighting and entertainment system may avoid a common problem of power allocation. In other words, while there may be a limited number of power outlets available for use in places where grooming routines may be practiced, incorporating an auxiliary power outlet 30 on the body of the frame 10 may ensure that a user may contemporaneously power the lighting and entertainment system as well any additionally desirable electronic devices.

In some embodiments, the auxiliary power outlet 30 may comprise an about 110 volt to about 120 volt alternating current outlet disposed on the frame 10. The auxiliary power outlet 30 may even be operative to receive a power supply cord associated with the user's personal electronic device. This may prevent draining any local battery associated with such device while transmitting media through the speakers.

In FIGS. 1 and 2, the vanity lighting and entertainment system is drawn as a standalone unit with a base 50 configured to rest on a surface such as a countertop, desktop, or tabletop. However, it is contemplated that the system may alternatively be configured for mounting along or against a relatively vertical surface such as a wall. Indeed, in some embodiments, suction cups, adhesive members, or even voids configured to receive mounting devices such as hooks, screws and nails, may be disposed along a back side of the frame 10 to enable securement of the system to a wall or other mirror. In such cases, the base 50 may be, though need not necessarily be, eliminated. One skilled in the art will recognize that the particular form of the base may vary as well. For instance, an optionally, hingedly deployable support may be disposed along the back side of the frame 10.

Additionally, it should be apparent that the particular shape, color, and material defined by and comprising the frame 10, mirror 12, and lights 14, will not limit the invention. While the figures illustrate a rectangular frame 10 and mirror 12, for example, it is contemplated that such elements may take on a limitless variety of shapes as may be desirable. For instance, the foregoing may be formed as a rectangle, square, heart, star, oval, or any other regular or irregular shape. Thus, it should be apparent that the particular configuration of elements comprising the lighting system illustrated in the figures is offered by way of example only and not of limitation.

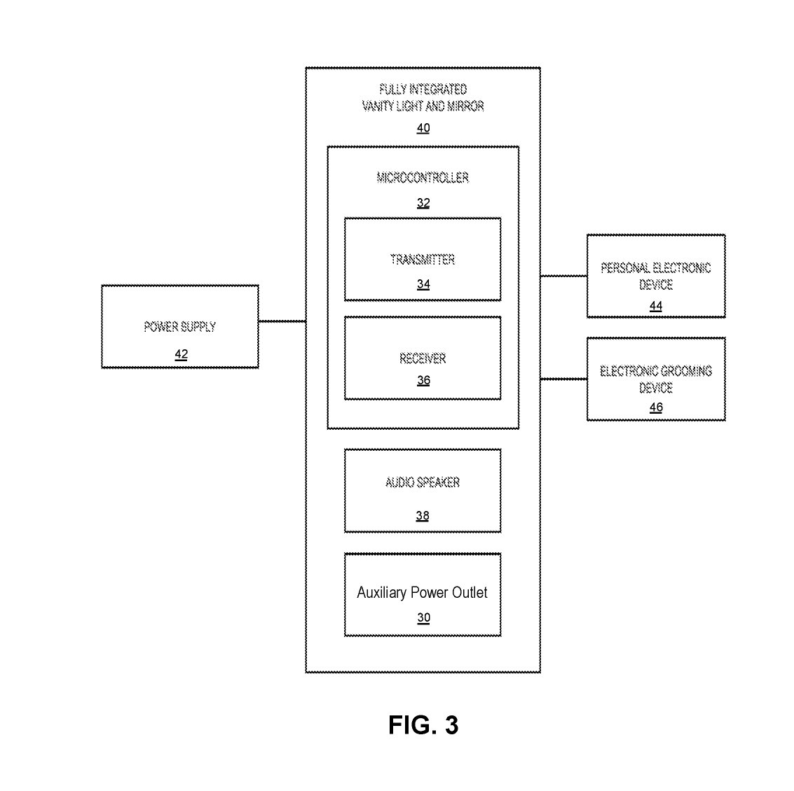

A block diagram illustrating one embodiment of the possible coupling of elements comprising the fully integrated vanity lighting and entertainment system is provided in FIG. 3. Thus it may be seen that the fully integrated vanity light and mirror 40 comprises a microcontroller 32, itself comprising a digital audio transmitter 34 and receiver 36, at least one audio speaker, and an embodiment of the auxiliary power outlet 30 is coupled to a power supply 42. This may be effected by way of a power cord, battery, or other means of supplying electrical power as may be available or otherwise desired. Then, owing to the auxiliary power outlet 30, additional electronic devices such as a personal electronic device 44 and an electronic grooming device 46 may be electrically coupled to the fully integrated vanity light and mirror 40.

Other non limiting elements may be integrated with the system without departing from the invention. For instance, the frame 10 may comprise additional dampening elements to prevent audio transmissions from warping or otherwise interfering with the operation of other elements comprising the system.

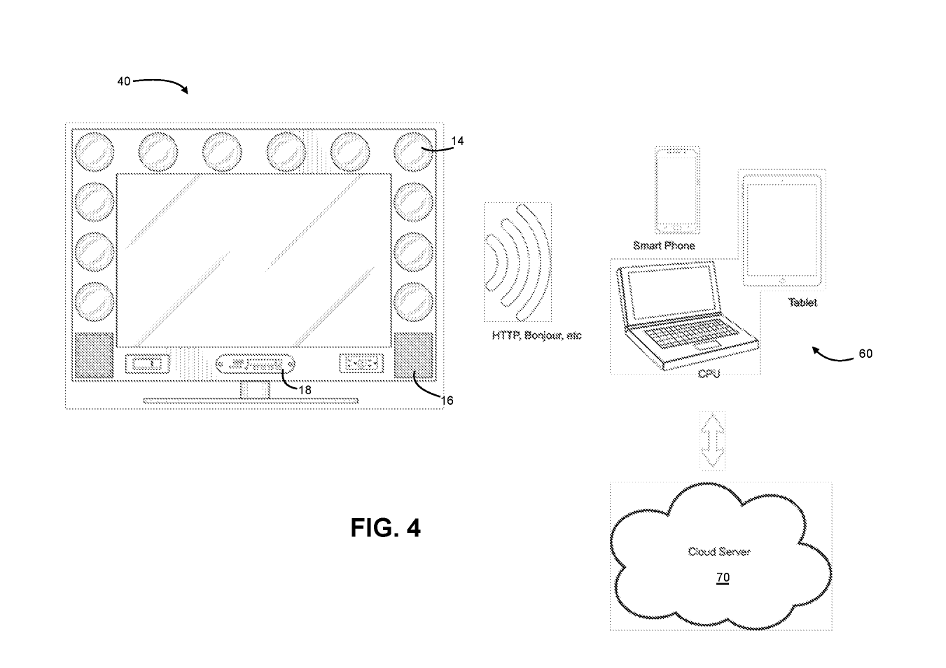

One embodiment of a networked environment in which the vanity lighting and entertainment system may be operated wirelessly is illustrated in FIG. 4. One embodiment may include a vanity light and mirror 40 comprising features discussed above. Said vanity light and mirror 40 may be communicatively coupled to a personal electronic device. More particularly, in such embodiments, such personal electronic device may be wirelessly communicatively coupled to any audio decoders 18, and related microcontrollers and audio speakers 16, integrated with the vanity lighting and entertainment system, though of course it is contemplated that the personal electronic device may also be wirelessly communicatively coupled to the lights 14 and other features comprising the vanity light and mirror 40. As discussed above, the personal electronic device may be a wireless communication device 60, such as a cellular mobile phone, lap-top, or desktop computer capable of connecting to a cloud server 70 or other electronic storage system known in the art. Audio media such as music, audio books and other entertainment may be accessible to the user from such cloud server 70 through his or her personal electronic device.

The personal electronic devices 60 may include a proprietary user interface. A variety of audio commands may be stored in one or any of the personal electronic devices 60. By way of example and for illustration purposes only, said audio commands may turn on and/or off any playable media transmitted through the one or more speakers 16 as desired by the user. Said audio commands may vary the volume of any transmissions through the one or more speakers 16 as desired by the user. Of course, it should be understood by those of ordinary skill in the art, that said proprietary software may be used to execute a wide variety of commands or macros different from those mentioned above.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, circuits defining and enabling electrical communication between and among elements comprising the system may be arranged variously while achieving desirable results. Similarly, elements, such as operative switches and even speakers, may be variously placed on and in relation to other elements comprising the invention according to ergonomic, electrical, aesthetic, and other considerations. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the fully integrated vanity lighting system with which that terminology is associated. In general, the terms used in the following claims should not be constructed to limit the fully integrated vanity lighting and entertainment system to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the fully integrated vanity lighting and entertainment system is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the fully integrated vanity lighting and entertainment system.

What is claimed is:

1. A fully integrated vanity lighting system, comprising:
a mirror supported by a frame;
a light source disposed along the frame;
a microcontroller operative to receive audio signals from a personal electronic device and transmit such signals through at least one speaker disposed in the frame;
a means for supplying power to the light source, microcontroller, and at least one speaker; and
an auxiliary power outlet configured to transmit supplied power to one or more additional electronic devices coupled to the auxiliary power outlet.

2. The vanity lighting system of claim 1, wherein the auxiliary power outlet comprises an about 110 volt to about 120 volt alternating current outlet disposed on the frame.

3. The vanity lighting system of claim 1, wherein the microcontroller comprises a digital signal decoder operative to wirelessly receive audio signals from the personal electronic device.

4. The vanity lighting system of claim 1, wherein the microcontroller comprises a digital signal decoder operative to receive audio signals from the personal electronic device by physically coupling the personal electronic device to the digital signal decoder via any of a USB cable and wired auxiliary input.

5. The vanity lighting system of claim 1, wherein a dimmer switch is disposed on the frame and in electrical communication with the light source to enable optional variation of lighting intensity.

6. The vanity lighting system of claim 1, wherein means for mounting the frame on a vertical surface is disposed on a portion of the frame.

7. The vanity lighting system of claim 1, wherein means for supporting the frame on a horizontal surface is disposed on a portion of the frame.
